(19) United States
(12) Patent Application Publication
(10) Pub. No.: US 2019/0119573 A1
(43) Pub. Date: Apr. 25, 2019

(54) COMPOSITION AND LIQUID CRYSTAL DISPLAY DEVICE

(71) Applicant: DIC Corporation, Tokyo (JP)

(72) Inventors: Go Sudo, Kita-adachi-gun (JP); Makoto Negishi, Kita-adachi-gun (JP)

(73) Assignee: DIC Corporation, Tokyo (JP)

(21) Appl. No.: 16/096,410

(22) PCT Filed: May 25, 2017
(86) PCT No.: PCT/JP2017/019517

§ 371 Date: Oct. 25, 2018

(30) Foreign Application Priority Data
Jun. 10, 2016 (JP) 2016-116199

(51) Int. Cl. C09K 19/30

(52) U.S. Cl. CPC C09K 19/3066; G02F 1/133723

(57) ABSTRACT

The present inventors have completed the present invention by examining various liquid crystal compounds and various chemical substances and finding that particular liquid crystal compounds can he combined to achieve the object. The composition contains compounds represented by the general formulae (i) to (vi). The liquid crystal display device contains the composition.

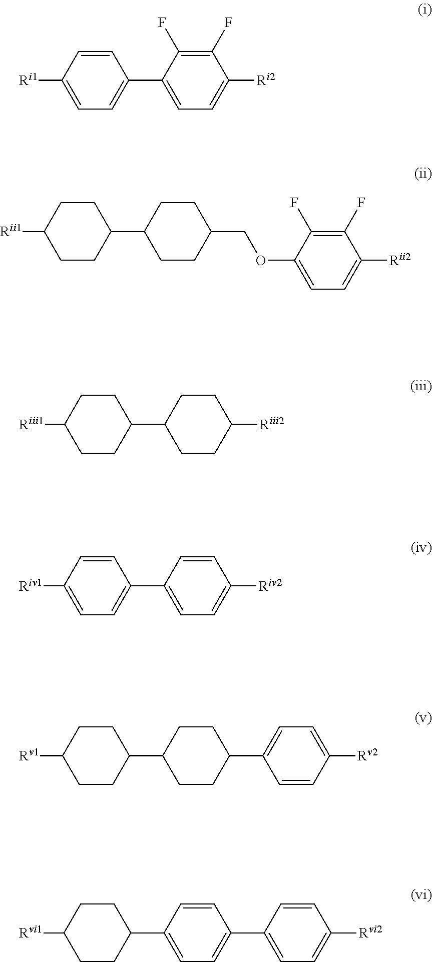

### TECHNICAL FIELD

The present invention relates to a composition with negative dielectric constant anisotropy (Δε) useful as a liquid crystal display material and to a liquid crystal display device containing the composition.

### BACKGROUND ART

Liquid crystal display devices containing compositions with negative Δε are widely used in liquid crystal TVs. Compositions for use in such applications require better characteristics, for example, a high nematic phase upper limit temperature Tₙᵢ, high Δε, low rotational viscosity (γ₁), and high nematic phase stability at low temperatures. Furthermore, such compositions should be less likely to cause display defects, such as image-sticking, in display devices, be less likely to cause drop marks during the manufacture, and be stably ejected in an ODF process. Thus, known liquid crystal compositions cannot fully satisfy these requirements.

### CITATION LIST

### Patent Literature

PTL 1: WO 2014/006963

PTL 2: WO 2014/148157

PTL 3: WO 2015/060056

### SUMMARY OF INVENTION

### Technical Problem

The present invention provides a liquid crystal composition that does not adversely affect the characteristics of liquid crystal display devices, such as Tₙᵢ, Δε, γ₁, and nematic phase stability at low temperatures, as well as the image-sticking characteristics, is less likely to cause drop marks during the manufacture, and has lower volatility in an ODF process. The present, invention also provides a liquid crystal display device containing the composition.

### Solution to Problem

The present inventors have completed the present invention by examining various liquid crystal compounds and various chemical substances and finding that particular liquid crystal compounds can be combined to achieve the object.

There is provided a composition containing compounds represented by the general formulae (i) to (vi), a liquid crystal display device containing the composition, and a vertical alignment (VA) device, a fringe field switching (FFS) device, or in plane switching (IPS) containing the composition.

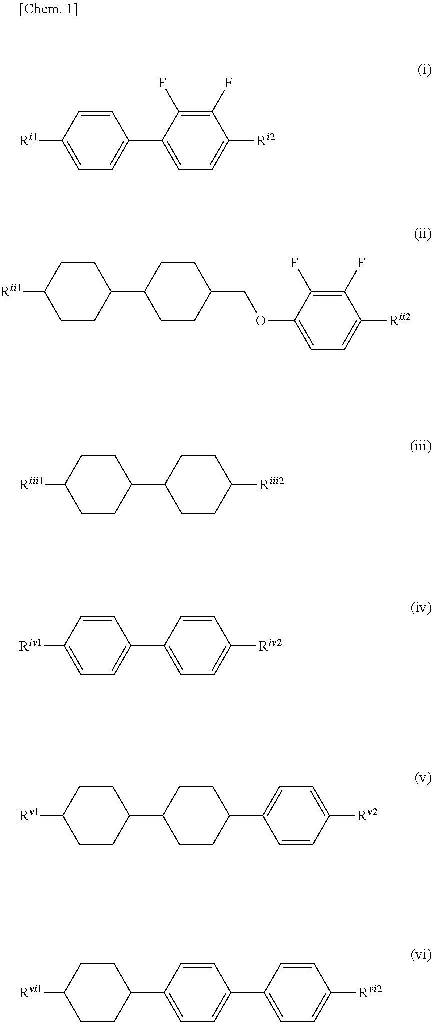

(In the formula, Rⁱ¹, Rⁱⁱ¹, Rⁱⁱⁱ¹, Rⁱⁱⁱ², R^{iv1}, R^{iv2}, R^{v1}, R^{v2}, R^{vi1}, and R^{vi2} independently denote an alkyl group having 1 to 8 carbon atoms, and Rⁱ² and Rⁱⁱ² independently denote an alkyl group having 1to 8 carbon atoms or an alkoxy group having 1 to 8 carbon atoms.)

### Advantageous Effects of Invention

A composition with negative dielectric constant anisotropy according to the present invention can have very low viscosity, high nematic phase stability at low temperatures, and a very small change in specific resistance or voltage holding ratio caused by heating or light irradiation, thereby providing products with high practicality and reliability. VA or FFS liquid crystal display devices containing such a composition can exhibit high-speed response at desired drive voltages. Due to its lower volatility, a liquid crystal composition according to the present invention can stably exhibit its performance in a process of manufacturing a liquid crystal display device, is less likely to cause display defects in the process, and allows a liquid crystal display device to be manufactured in high yield. Thus, a liquid crystal composition according to the present invention is very useful.

### BRIEF DESCRIPTION OF DRAWINGS

FIG. 1 is a schematic view of a liquid crystal display device according to the present invention.

FIG. 2 is a fragmentary enlarged plan view of a region within the line II of an electrode layer 3 formed on a substrate 2 in FIG. 1.

FIG. 3 is a cross-sectional view of the liquid crystal display device illustrated in FIG. 1 taken along the line III-III of FIG. 2.

FIG. 4 is a schematic view of the alignment direction of a liquid crystal induced by an alignment film 4.

FIG. 5 is an enlarged plan view of an electrode of a liquid crystal display device.

FIG. 6 is another cross-sectional view of the liquid crystal display device illustrated in FIG. 1 taken along the line III-III of FIG. 2.

### DESCRIPTION OF EMBODIMENTS

As described above, a VA or IPS liquid crystal display device that has a particular n-type liquid crystal composition and a particular device structure has been found in the present invention. The term “n-type”, as used herein, refers to negative Δε.

Some embodiments of a liquid crystal composition according to the present invention will now be described below.

Rⁱ¹, Rⁱⁱ¹, Rⁱⁱⁱ¹, Rⁱⁱⁱ², R^{iv1}, R^{iv2}, R^{v1}, R^{v2}, R^{vi1}, and R^{vi2} are preferably linear alkyl groups having 1to 8 carbon atoms, preferably a methyl group, an ethyl group, a propyl group, a butyl group, and a pentyl group, preferably an ethyl group, a propyl group, a butyl group, and a pentyl group.

Rⁱ² and Rⁱⁱ² are preferably linear alkyl groups having 1 to 5 carbon atoms or linear alkoxyl groups having 1 to 5 carbon atoms, preferably a methyl group, an ethyl group, a propyl group, a butyl group, a pentyl group, a methoxy group an ethoxy group, a propoxy group, a butoxy group, or a pentoxy group.

The compounds represented by the general formula (i) may be used alone or as a combination of two or more thereof. Although compounds of any types may be combined, these compounds are appropriately combined in a manner that depends on the desired characteristics, such as solubility at low temperatures, transition temperature, electrical reliability, and birefringence index. For example, one, two three, four, five, or more compounds are used in one embodiment of the present invention.

The amount is preferably increased when improved Δε is regarded as important, is effectively increased when solubility at low temperatures is regarded as important, and is effectively decreased when Tₙᵢ is regarded as important. When reduced drop marks or improved image-sticking characteristics are desired, the amount is preferably set in a medium range. An increase in Δε enables low voltage driving. In a liquid crystal composition to the present invention, a compound represented by the general formula (i) and a compound represented by the general formula (ii) can be used alone or in combination to provide a liquid crystal display device with a low driving voltage and satisfactory high-speed response. More specifically, the combination preferably includes one compound represented by the general formula (i) and two compounds represented by the general formula (ii), two compounds represented by the general formula (i) and one compound represented by the general formula (ii), or two compounds represented by the general formula (i) and two compounds represented by the general formula (ii).

The lower limit of the preferred amount of a compound represented by the formula (i) is 5%, 7%, 9%, 11%, 13%, 15%, or 17% of the total amount of a composition according to the present invention. The upper limit of the preferred amount is 23%, 20%, 18%, 15%, 13%, or 11% of the total amount of a composition according to the present invention.

A compound represented by the general formula (i) is preferably a compound selected from the compound group represented by the formulae (i.1) to (i.14), preferably a compound represented by one of the formulae (i.1) to (i.5), preferably a compound represented by on of the formulae (i.2), (i.3), and (i.5).

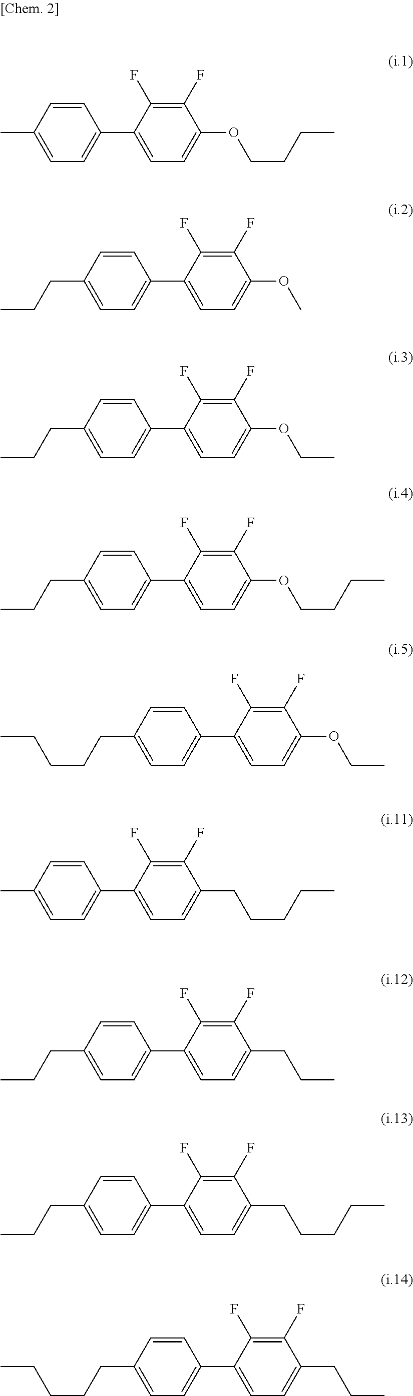

The compounds represented by the formulae (i.1) to (i.14) may be used alone or in combination. The lower limit of the preferred amount of each compound or these compounds is 3%, 5%, or 7% of the total amount of a composition according to the present invention. The upper limit of the preferred amount is 15%, 13%, 11%, 10%, or 9% of the total amount of a composition according to the present invention.

When two or three compounds represented by the formulae (i.2), (i.3), and (i.5) are used in combination, the lower limit of the preferred total amount of these compounds is 5%, 7%, 9%, 11%, 13%, 15%, or 17%. The upper limit of the preferred amount is 25%, 23%, 20%, 13%, 15%, 13%, or 11% of the total amount of a composition according to the present invention.

The compounds represented by the general formula (ii) may be used alone or as a combination of two or more thereof. Although compounds of any types may be combined, these compounds are appropriately combined in a manner that depends on the desired characteristics, such as solubility at low temperatures, transition temperature, electrical reliability, and birefringence index. For example, one, two three, four, five, or more compounds are used in one embodiment of the present invention.

The amount is preferably increased when improved Δε is regarded as important, is effectively decreased when solubility at low temperatures is regarded as important, and is effectively increased when TNI is regarded as important. When reduced drop marks or improved image-sticking characteristics are desired, the amount is preferably set in a medium range.

The lower limit of the preferred amount of a compound represented by the formula (ii) is 10%, 13%, 15%, 17%, 20%, 23%, 25%, 27%, 30%, 33%, or 35% of the total amount of a composition according to the present invention. The upper limit of the preferred amount is 40%, 37%, 35%, 33%, or 30% of the total amount of a composition according to the present invention.

A compound represented by the general formula (ii) is preferably a compound selected from the compound group represented by the formulae (ii.1) to (ii15), preferably a compound represented by one of the formulae (ii.1) to (ii.15), preferably a compound represented by the formulae (ii.2) or (ii.4).

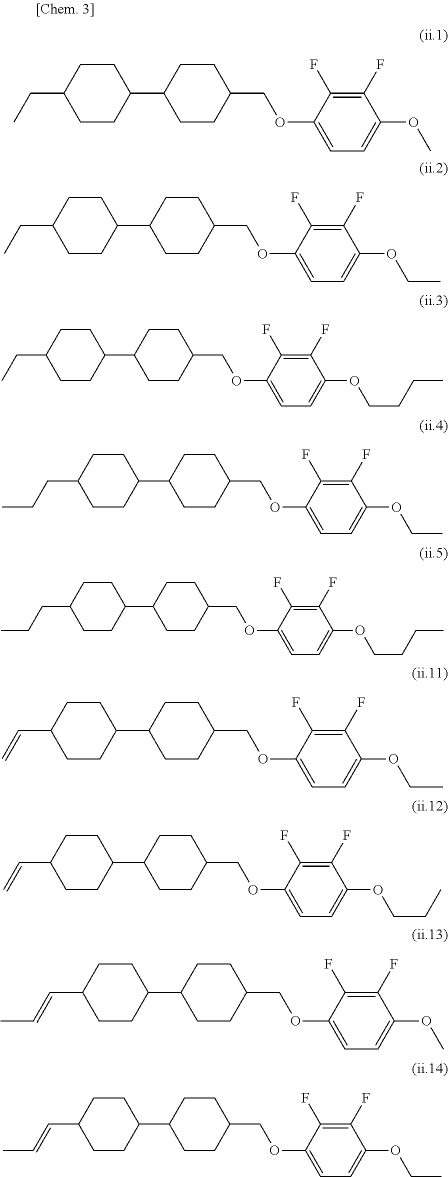

The compounds represented by the formulae (ii.2) and (ii.4) may be used alone or in combination. The lower limit of the preferred amount of each compound or these compounds is 10%, 13%, 15%, 17%, 20%, 23%, 25%, 27%, 30%, 33%, or 35% of the total amount of a composition according to the present invention. The upper limit of the preferred amount is 40%, 37%, 35%, 33%, or 30% of the total amount of a composition according to the present invention.

The compounds represented by the general formula (iii) may be used alone or as a combination of two or more thereof Although compounds of any types may be combined, these compounds are appropriately combined in a manner that depends on the desired characteristics, such as solubility at low temperatures, transition temperature, electrical reliability, and birefringence index. For example, one, two three, four, five, or more compounds are used in one embodiment of the present invention.

The lower limit of the preferred amount is 1%, 2%, 3%, 5%, 7%, 10%, 15%, 18%, 20%, 22%, 25%, 28%, or 30% of the total amount of a composition according to the present invention. The upper limit of the preferred amount is 45%, 43%, 40%, 38%, 35%, 33%, or 30% of the total amount of a composition according to the present invention.

When a low viscosity and a high response speed are required for a composition according to the present invention, the lower limit is preferably high, and the upper limit, is preferably high. When a composition according to the present invention with a high Tni and high temperature stability is required, the lower limit is preferably medium, and the upper limit is preferably medium. When the dielectric constant anisotropy is increased to maintain a low driving voltage, the lower limit is preferably low, and the upper limit is preferably low.

A compound represented by the general formula (iii) is preferably a compound selected from the compound group represented by the formulae (iii.1) to (iii.4), preferably a compound represented by the formula (iii.1), (iii.3), or (iii.4). In particular, the compound represented by the formula (iii.1) is preferred in order to particularly improve the response speed of a composition according to the present invention. When high Tni rather than high response speed is required, a compound represented by the formula (iii.3) or (iii.4) is preferably used. However, the total amount of these compounds greater than or equal to 20% is unfavorable for solubility at low temperatures.

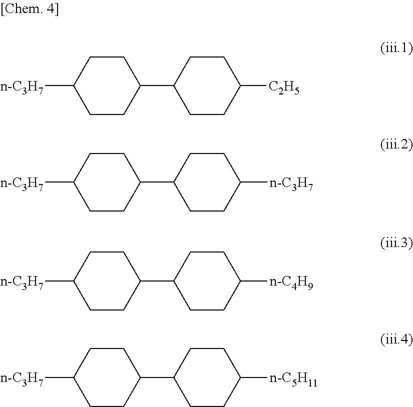

The lower limit of the preferred amount of the compound represented by the formula (iii.1) is 1%, 2%, 3%, 5%, 7%, 10%, 13%, 15%, 18%, or 20% of the total amount of a composition according to the present invention. The upper limit of the preferred amount is 20%, 17%, 15%, 13%, 10%, 8% 7%, or 6% of the total amount of a composition according to the present invention. When improved volatility is regarded as important, the amount of the compound represented by the formula (iii.1) is preferably 20% or less, 10% or less, 5% or less, or 0%.

The lower limit of the preferred total amount of a compound represented by the formula (iii.3) or (iii.4) is 1% 2%, 3%, 5%, 7%, 10%, 13%, 15%, 18%, or 20%. The upper limit of the preferred amount is 30%, 27%, 25%, 23%, 20%, 17%, 15% 13%, 10%, 8%, 7%, or 6% of the total amount of a composition according to the present invention.

In the combined use of compounds represented by the general formula (iii), when improved response speed is regarded as important, the compound represented by the formula (iii.1) is preferably mainly used, in addition to a small amount of a compound represented by the formula (iii.3) or (iii.4). On the other hand, a compound represented by the formula (iii.3) or (iii.4) is preferably mainly used to improve the volatility of the compound represented by the formula (iii.1).

The compounds represented by the general formula (iv) may be used alone or as a combination of two or more thereof. Although compounds of any types may be combined, these compounds are appropriately combined in a manner that depends on the desired characteristics, such as solubility at low temperatures, transition temperature, electrical reliability, and birefringence index. For example, one, two, three, four, five, or more compounds are used in one embodiment of the present invention.

The lower limit of the preferred amount of a compound represented by the formula (iv) is 5%, 7%, 10%, 13%, or 15% of the total amount of a composition according to the present invention. The upper limit of the preferred amount is 25%, 23%, 20%, 17%, 15%, 13%, 10%, or 8% of the total amount of a composition according to the present invention.

When a high birefringence index is desired, greater amounts are effective. When a high Tni is regarded as important, smaller amounts are effective. When reduced drop marks or improved image-sticking characteristics are desired, the amount is preferably set in a medium range.

A compound represented by the general formula (iv) is preferably a compound selected from the compound group represented by the formulae (iv.1) and (iv.2).

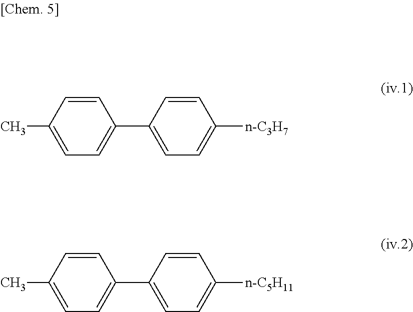

The lower limit of the preferred total amount of a compound represented by the formula (iv.1) or (iv.2) is 5%, 7%, 10%, 13%, or 15%. The upper limit of the preferred amount is 25%, 23%, 20%, 17%, 15%, 13%, 10%, or 8% of the total amount of a composition according to the present invention.

The compounds represented by the general formula (v) may be used alone or as a combination of two or more thereof Although compounds of any types may be combined, these compounds are appropriately combined in a manner that depends on the desired characteristics, such as solubility at low temperatures, transition temperature, electrical reliability, and birefringence index. For example, one, two three, four, five, or more compounds are used in one embodiment of the present invention.

The amount of a compound represented by the general formula (v) in a composition according to the present invention should be appropriately adjusted in a manner that depends on the desired characteristics, such as solubility at low temperatures, transition temperature, electrical reliability, birefringence index, process compatibility, drop marks, image-sticking, and dielectric constant anisotropy.

The lower limit of the preferred amount of a compound represented by the formula (v) is 1%, 2%, 3%, 5%, 7%, or 10% of the total amount of a composition according to the present invention. The upper limit of the preferred amount of a compound represented by the formula (v) is 15%, 13%, 10%, 8%, or 5% of the total amount of a composition according to the present invention.

For example, a compound represented by the general formula (v) is preferably a compound represented by one the formulae (v.1) to (v.3), preferably the compound represented by the formula (v.1).

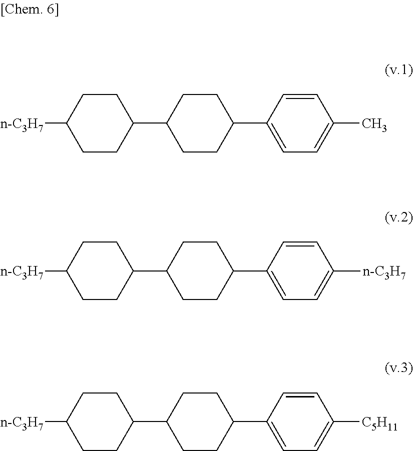

Depending on the desired characteristics, such as solubility at low temperatures, transition temperature, electrical reliability, and birefringence index, the compound represented by the formula (v.1) may be contained, or both the compound represented by the formula (v.1) and the compound represented by the formula (v.2) may be contained.

The lower limit of the preferred amount of the compound represented by the formula (v.1) is 3%, 5%, 7%, 9%, 11%, 12%, 13%, 18%, or 21% of the total amount of a composition according to the present invention. The preferred upper limit is 45, 40%, 35%, 30%, 25%, 23%, 20%, 18%, 15%, 13%, 10%, or 8%.

The compounds represented by the general formula (vi) may be used alone or as a combination of two or more thereof. Although compounds of any types may be combined, these compounds are appropriately combined in a manner that depends on the desired characteristics, such as solubility at low temperatures, transition temperature, electrical reliability, and birefringence index. For example, one, two, three, four, five, or more compounds are used in one embodiment of the present invention.

The amount of a compound represented by the general formula (vi) in a composition according to the present invention should be appropriately adjusted in a manner that depends on the desired characteristics, such as solubility at low temperatures, transition temperature, electrical reliability, birefringence index, process compatibility, drop marks, image-sticking, and dielectric constant anisotropy.

The lower limit of the preferred amount of a compound represented by the formula (vi) is 1%, 2%, 3%, 5%, 7%, 10%, 14%, 16%, 20%, 23%, 26%, 30%, 35%, or 40% of the total amount of a composition according to the present invention. The upper limit of the preferred amount of a compound represented by the formula (vi) is 50%, 40%, 35%, 30%, 20%, 15%, 10%, or 5% of the total amount of a composition according to the present invention.

A compound represented by the general formula (vi) is preferably a compound represented by the formula (vi.1) or (vi.2), particularly preferably the compound represented by the formula (vi.1).

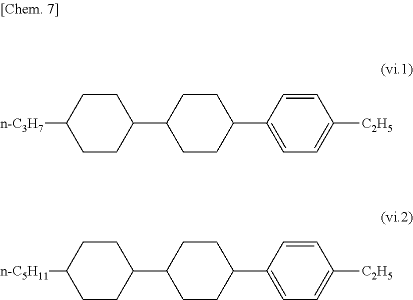

The lower limit of the preferred amount of these compounds is 1%, 2%, 3%, 5%, or 7% of the total amount of a composition according to the present invention. The upper limit of the preferred amount of these compounds is 20%, 15% 13%, 10%, or 9%.

The lower limit, of the preferred total amount of a compound represented by the general formula (i) and a compound represented by the general formula (ii) is 30%, 35% 38%, or 40% of the total amount of a composition according to the present invention. The upper limit of the preferred amount is 50%, 47%, 45%, 43%, 40%, or 37% of the total amount of a composition according to the present invention.

The lower limit of the preferred total amount of a compound represented by the general formula (iii), a compound represented by the general formula (iv), a compound represented by the general formula (v), and a compound represented by the general formula (vi) is 30%, 35%, 38%, or 40% of the total amount of a composition according to the present invention. The upper limit of the preferred amount is 50%, 47%, 45%, 43%, 40%, or 37% of the total amount of a composition according to the present invention.

The lower limit of the preferred total amount of a compound represented by the general formula (i) and a compound represented by the general formula (iv) is 10%, 13%, 15%, or 17% of the total amount of a composition according to the present invention. The upper limit of the preferred amount is 35%, 33%, 30%, 28%, 25%, 24%, 22%, 20%, or 18% of the total amount of a composition according to the present invention.

The lower limit of the preferred total amount of a compound represented by the general formula (v) and a compound represented by the general formula (vi) is 7%, 10%, 13%, or 15% of the total amount of a composition according to the present invention. The upper limit of the preferred amount is 30%, 27%, 25%, 23%, or 20% of the total amount of a composition according to the present invention.

The lower limit of the preferred total amount of a compound represented by the general formula (i), a compound represented by the general formula (ii), a compound represented by the general formula (iii), a compound represented by the general formula (iv), a compound represented by the general formula (v), and a compound represented by the general formula (vi) is 80%, 83%, 85%, 87%, 90%, 93%, 95%, 97%, 98%, or 99% of the total amount of a composition according to the present invention. The upper limit of the preferred amount is 97%, 95%, 93%, or 90% of the total amount of a composition according to the present invention, or substantially no other liquid crystal compound is contained as a liquid crystal compound except a stabilizer, a polymerizable compound, and the like.

Another liquid crystal compound may be contained in addition to a compound represented by the general formula (i), a compound represented by the general formula (ii), a compound represented by the general formula (iii), a compound represented by the general formula (iv), a compound represented by the general formula (v), and a compound represented by the general formula (vi). The preferred lower limit of the total amount of the other compound is 10%, 7%, 5%, or 3%, preferably substantially zero percent.

Examples of the other liquid crystal compound other than the compounds represented by the general formula (i), the compounds represented by the general formula (ii), the compounds represented by the general formula (iii), the compounds represented by the general formula (iv), the compounds represented by the general formula (v), and the compounds represented by the general formula (vi) include the following compounds.

A compound represented by the formula (3CCV), (3CCV1), or (2CCV1).

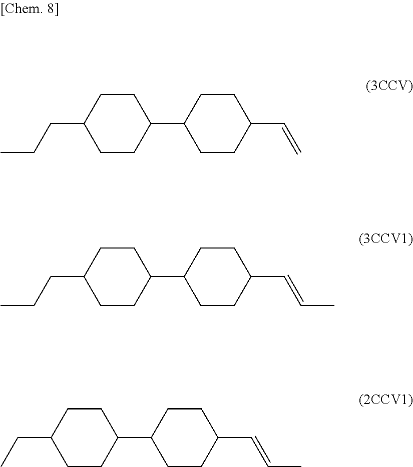

In order to reduce the change in voltage holding ratio (VHR) caused by heating or light irradiation, the amount of a compound represented by the formula (3CCV), (3CCV1), or (2CCV1) is preferably 10% or less, 5% or less, or 0%. In order to improve image-sticking, drop marks, and volatility, the amount of the compound represented by the formula (3CCV) is preferably 10% or less, 5% or less, or 0%.

A compound represented by the general formula (N-1-1).

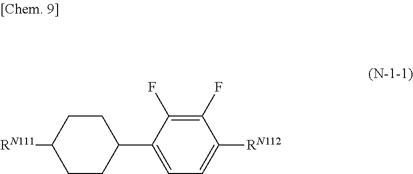

(In the formula, Rⁿⁱ¹¹ and R^{Ni12} independently denote an alkyl group having 1to 8 carbon atoms or an alkoxy group having 1 to 8 carbon atoms.)

A compound represented by the general formula (N-1-2).

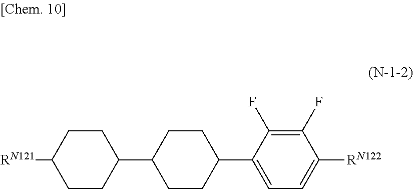

(In the formula, R^{N121} and R^{N122} independently denote an alkyl group having 1to 8 carbon atoms or an alkoxy group having 1to 8 carbon atoms.)

A compound represented by the general formula (N-1-3).

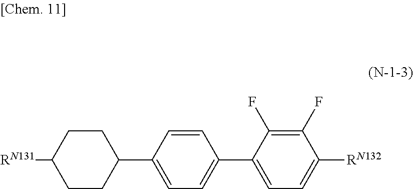

(In the formula, R^{N131} and R^{N132} independently denote an alkyl group having 1 to 8 carbon atoms or an alkoxy group having 1to 8 carbon atoms.)

A compound represented by the general formula (N-1-5).

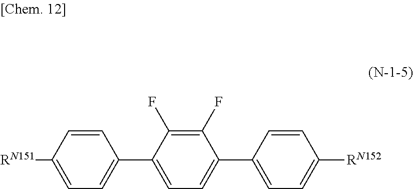

(In the formula, R^{N151} and R^{N152} independently denote an alkyl group having 1to 8 carbon atoms or an alkoxy group having 1to 8 carbon atoms.)

A compound represented by the general formula (N-1-10).

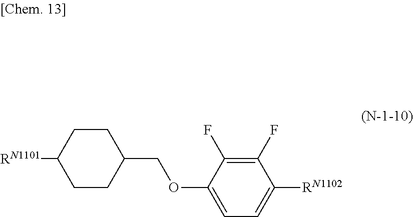

(In the formula, R^{N1101} and R^{N1102} independently denote an alkyl group having 1to 8 carbon atoms or an alkoxy group having 1 to 8 carbon atoms.)

A compound represented by the general formula (L-2).

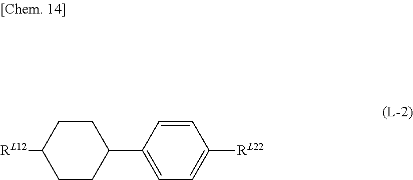

(In the formula, R^{L21} and R^{L22} independently denote an alkyl group having 1 to 8 carbon atoms or an alkoxy group having 1to 8 carbon atoms.)

R^{L21} preferably denotes an alkyl group having 1 to 5 carbon atoms or an alkenyl group having 2 to 5 carbon atoms, and R^{L22} preferably denotes an alkyl group having 1 to 5 carbon atoms, an alkenyl group having 4 or 5 carbon atoms, or an alkoxy group having 1 to 4 carbon atoms.

The compounds represented by the general formula (L-1) may be used alone or as a combination of two or more thereof. Although compounds of any types may be combined, these compounds are appropriately combined in a manner that depends on the desired characteristics, such as solubility at low temperatures, transition temperature, electrical reliability, and birefringence index. For example, one, two three, four, five, or more compounds are used in one embodiment of the present invention.

When solubility at low temperatures is regarded as important, greater amounts are effective. When the response speed is regarded as important, smaller amounts are effective. When reduced drop marks or improved image-sticking characteristics are desired, the amount is preferably set in a medium range.

The lower limit of the preferred amount of a compound represented by the formula (L-2) is 1%, 2%, 3%, 5%, 7%, or 10% of the total amount of a composition according to the present invention. The upper limit of the preferred amount is 20%, 15%, 13%, 10%, 8%, 7%, 6%, 5%, or 3% of the total amount of a composition according to the present invention.

A compound represented by the general formula (L-2) is preferably a compound selected from the compound group represented by the formulae (L-2.1) to (L-2.6), preferably a compound represented by the formula (L-2.1), (L-2.3), (L-2.4), or (L-2.6).

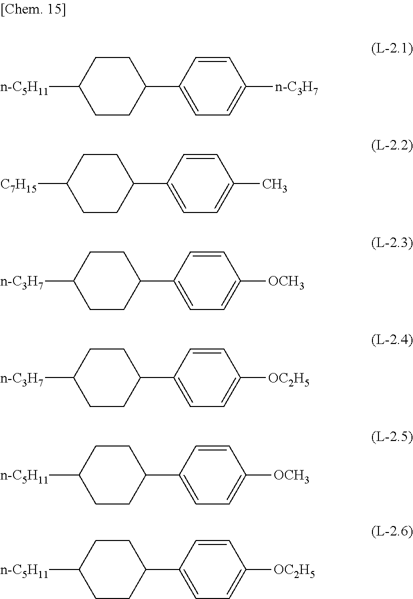

The lower limit of the preferred total amount of a compound represented by the general formula (i), a compound represented by the general formula (ii), a compound represented by the general formula. (N-1-1), a compound represented by the general formula (N-1-2), a compound represented by the general formula (N-1-3), a compound represented by the general formula (N-1-5), and a compound represented by the general formula (N-1-10) is 30%, 32%, 35%, 38%, 40%, 42%, 43%, 44%, 45%, or 46% of the total amount of a composition according to the present invention. The upper limit of the preferred amount is 70%, 68%, 65%, 63%, 62%, 60%, 58%, 55%, 53%, 52%, 50%, or 48%.

The lower limit of the preferred total amount of a compound represented by the general formula (iii), a compound represented by the general formula (iv), a compound represented by the general formula (v), a compound represented by the general formula (vi), and a compound represented by the general formula (L-2) is 35%, 38%, 40%, 42%, 43%, 44%, 45%, 46%, 48%, 50%, 52%, or 53% of the total amount of a composition according to the present invention. The upper limit of the preferred amount is 75%, 73%, 70%, 63%, 65%, 63%, 62%, 50%, 58%, or 55%.

The lower limit of the preferred total amount of a compound represented by the general formula (i), a compound represented by the general formula (ii), a compound represented by the general formula (iii), a compound represented by the general formula (iv), a compound represented by the general formula (v), a compound represented by the general formula (vi), a compound represented by the general formula (N-1-1), a compound represented by the general formula (N-1-2), a compound represented by the general formula (N-1-3), a compound represented by the general formula (N-1-5), a compound represented by the general formula (N-1-10), and a compound represented by the general formula (L-2) is 80%, 85%, 88%, 90%, 92%, 93%, 94%, 95%, 96%, 97%, 98%, 99%, or 100% of the total amount of a composition according to the present invention. The upper limit of the preferred amount is 100%, 99%, 96%, or 95%.

The lower limit e preferred total amount of a compound represented by the general formul (i), a compound represented by the general formula (ii), a compound represented by the general formula (iii), a compound represented by the general formula (iv), a compound represented by the general formula (v), a compound represented by the general formula (vi) and a compound represented by the general formula (L-2) is 80%, 85%, 88%, 90%, 92%, 93%, 94%, 95%, 96%, 97% 98%, 99%, or 100% of the total amount of a composition according to the present invention. The upper limit of the preferred amount is 100%, 99%, 98%, or 95%.

A composition according to the present invention preferably contains no compound having a structure in which oxygen atoms are bonded together, such as a peroxy (—CO—OO—) structure, in its molecule.

When the reliability and long-term stability of a composition are regarded as important, the amount of compound(s) having a carbonyl group is preferably 5% or less more preferably 3% or less, still more preferably 1% or less most preferably substantially zero percent, of the total mass of the composition.

When stability under UV irradiation is regarded as important, the amount of compound(s) substituted with a chlorine atom is preferably 15% or less, preferably 10% or less, preferably 8% or less, more preferably 5% or less, preferably 3% or less, still more preferably substantially zero percent, of the total mass of the composition.

The amount of compound in which ail the ring structures of its molecule are 6-membered rings is preferably increased. The amount of compound in which all the ring structures of its molecule are 6-membered rings is preferably 80% or more, more preferably 90% or more, still more preferably 95% or more, of the total mass of the composition. Most preferably, a composition is composed substantially solely of a compound in which all the ring structures of its molecule are 6-merbered rings.

In order to suppress the oxidative degradation of a composition, the amount of compound(s) having a cyclohexenylene group as a ring structure is preferably decreased. The amount of compound(s) having a cyclohexenylene group is preferably 10% or less, preferably 8% or less, more preferably 5% or less, preferably 3% or less, still more preferably substantially zero percent, of the total mass of the composition.

When improved viscosity and Tni are regarded as important, the amount of compound having a 2-methylbenzene-1,4-diyl group in its molecule in which a hydrogen atom may be substituted with a halogen is preferably decreased, and the amount of compound having the 2-methylbenzene-1,4-diyl group in its molecule is preferably 10% or less, preferably 8% or less, more preferably 5% or less, preferably 3% or less, still more preferably substantially zero percent, of the total mass of the composition.

The phrase “substantially zero percent”, as used herein, refers to zero percent except for incidental inclusions.

When a compound in a composition according to a first embodiment of the present invention has an alkenyl group as a side chain, and the alkenyl group is bonded to eyclohexane, then the alkenyl group preferably has 2 to 5 carbon atoms. When the alkenyl group is bonded to benzene, the alkenyl group preferably has 4 or 5 carbon atoms, and an unsaturated bond of the alkenyl group is preferably not directly bonded to benzene.

A liquid crystal composition for use in the present invention preferably has an average elastic constant (K_{AVG}) in the range of 10 to 25. The lower limit of the average elastic constant (K_{AVG}) is preferably 10, 10.5, 11, 11.5, 12, 12.3, 12.5, 12.8, 13, 13.3, 13.5, 13.8, 14, 14.3, 14.5, 14.8 15, 15.3, 15.5, 15.8, 16, 16.3, 16.5, 16.8, 17, 17.3, 17.5, 17.8, or 18. The upper limit of the average elastic constant (K_{AVG}) is preferably 25, 24.5, 24, 23.5, 23, 22.8, 22.5, 22.3, 22, 21.8, 21.5, 21.3, 21, 20.8, 20.5, 20.3, 20, 19.8, 19.5, 19.3, 19, 18.8, 18.5, 18.3, 18, 17.8, 17.5, 17.3 or 17. When a reduction in power consumption is regarded as important, the light amount of a backlight is effectively decreased, the light transmittance of a liquid crystal display device is preferably improved, and therefore K_{AVG} is preferably decreased. When improved response speed is regarded as important, K_{AVG} is preferably increased.

A composition according to the present invention can contain a polymerizable compound in order to produce a PS mode, transverse electric field PSA mode, or transverse electric field PSVA mode liquid crystal display device. One possible polymerizable compound may be a photopolymerizable monomer, which can be polymerized by an energy beam, such as light. For example, the polymerizable compound has a liquid crystal skeleton in which a plurality of six-membered rings, such as a biphenyl derivative and a terphenyl derivative, are linked. More specifically, a bifunctional monomer represented by the general formula (XX) is preferred.

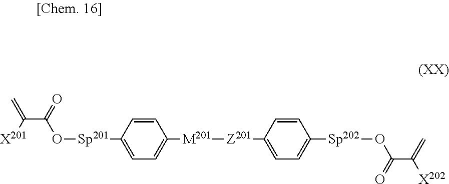

(In the formula, X²⁰¹ and X²⁰² independently denote a hydrogen atom or a methyl group,

Sp²⁰¹ and Sp²⁰² preferably independently denote a single bond, an alkylene group having 1to 8 carbon atoms, or —O—(CH₂)ₛ— (wherein s denotes an integer in the range of 2 to 7, and the oxygen atom is bonded to an aromatic ring),

Z²⁰¹ denotes —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (wherein Y¹ and Y² independently denote a fluorine atom or a hydrogen atom), —C≡C—, or a single bond, and

M²⁰¹ denotes a 1,4-phenylene group, a trans-1,4-cyclohexylene group, or a single bond. Any hydrogen atom in all the 1,4-phenylene groups in the formula may be substituted with a fluorine atom.)

Both of X²⁴¹ and X²⁰² preferably denote a hydrogen atom (a diacrylate derivative) or a methyl group (a dimethacrylate derivative). Alternatively, one of X²⁰¹ and X²⁰² preferably denotes a hydrogen atom, and the other preferably denotes a methyl group. With respect to the rate of polymerization of these compounds, diacrylate derivatives have the highest rates, dimethacrylate derivatives have low rates, and asymmetric compounds have medium rates. The preferred embodiment depends on the application. Dimethacrylate derivatives are particularly suitable for PSA display devices.

Sp²⁰¹ and Sp²⁰² independently denote a single bond, an alkylene group having 1to 8 carbon atoms, or —O—(CH₂)ₛ—. In PSA display devices, at least one of Sp²⁰¹ and Sp²⁰² is preferably a single bond, and a compound in which both of Sp²⁰¹ and Sp²⁰² are single bonds or an embodiment in which one of Sp²⁰¹ and Sp²⁰² is a single bond and the other is an alkylene group having 1to 8 carbon atoms or —O—(CH₂)ₛ— is preferred. In this case, 1 to 4 alkyl groups are preferred, and s preferably ranges from 1 to 4.

Z²⁰¹ is preferably —OCH₂—, —CH₂O—, —COO—, —OCO—, —CF₂O—, —OCF₂—, —CH₂CH₂—, —CF₂CF₂—, or a single bond, more preferably —COO—, —OCO—, or a single bond, particularly preferably a single bond.

M²⁰¹ denotes a 1,4-phenylene group in which any hydrogen atom may be substituted with a fluorine atom, a trans-1,4-cyclohexylene group, or a single bond, preferably a 1,4-phenylene group or a single bond. When C denotes a ring structure other than a single bond, Z²⁰¹ is also preferably a linking group other than a single bond. When M²⁰¹ denotes a single bond, Z²⁰¹ preferably denotes a single bond.

Thus, in the general formula (XX), more specifically, the ring structures between Sp²⁰¹ and Sp²⁰² preferably have the following structure.

In the general formula (XX), if M²⁰¹ denotes a single bond, and the ring structures are composed of two rings, the ring structures are preferably represented by the following formulae (XXa-1) to (XXa-5), more preferably the formulae (XXa-1) to (XXa-3), particularly preferably the formula (XXa-1).

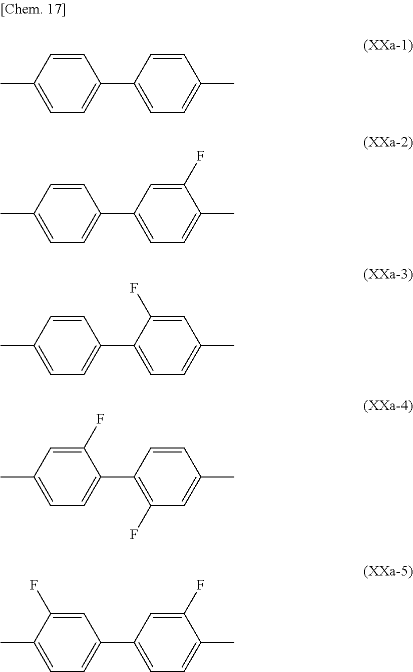

(In the formula, each end is bonded to Sp²⁰¹ or Sp²⁰².)

Polymerizable compounds having such a skeleton are most suitable for PSA liquid crystal display devices with respect to alignment regulating force after polymerization and can provide a satisfactory alignment state, thus causing little or no variation in display.

Thus, polymerizable monomers are particularly preferably represented by the general formulae (XX-1) to (XX-4), most preferably the general formula (XX-2).

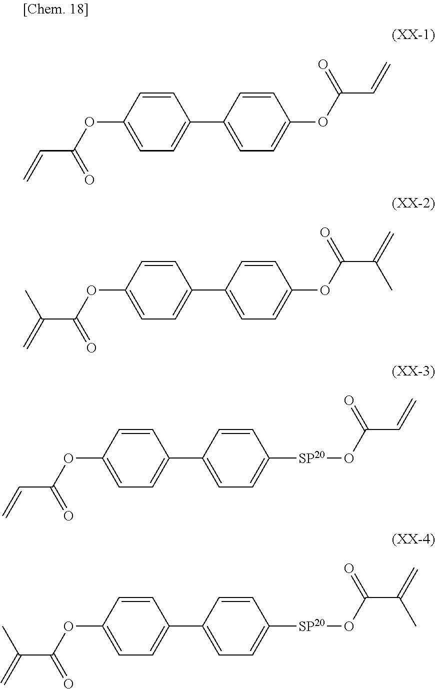

(In the formula, benzene may be substituted with a fluorine atom, and Sp²⁰ denotes an alkylene group having 2 to 5 carbon atoms.)

Although such a monomer in a composition according to the present invention can be polymerized without a polymerization initiator, the composition may contain a polymerization initiator to promote polymerization. Examples of the polymerization initiator include benzoin ethers, benzophenones, acetophenones, benzil ketals, and acylphosphine oxides.

A composition according to the present invention may further contain a compound represented by the general formula (Q).

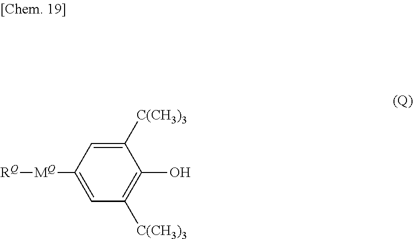

(In the formula, R^{Q} denotes a linear or branched alkyl group having 1 to 22 carbon atoms. One or two or more CH₂ groups in the alkyl group may be substituted with —O—, —CH═CH—, —CO—, —OCO—, —COO—, —C≡C—, —CF₂O—, and/or —OCF₂—, provided that oxygen atoms are not directly adjacent to each other. M^{Q} denotes a trans-1,4-cyclohexylene group, a 1,4-phenylene group, or a single bond.)

R^{Q} denotes a linear or branched alkyl group having 1 to 22 carbon atoms. One or two or more CH₂ groups in the alkyl group may be substituted with —O—, —CH═CH—, —CO—, —OCO—, —COO—, —C≡C—, —CF₂O—, and/or —OCF₂—, provided that oxygen atoms are not directly adjacent to each other. R^{Q} preferably denotes a linear alkyl group having 1 to 10 carbon atoms, a linear alkoxy group, a linear alkyl group in which one CH₂ group is substituted with —OCO— or —COO—, a branched alkyl group, a branched alkoxy group, or a branched alkyl group in which one CH₂ group is substituted with —OCO— or —COO—, more preferably a linear alkyl group having 1 to 20 carbon atoms, a linear alkyl group in which one CH₂ group is substituted with —OCO— or —COO—, a branched alkyl group, a branched alkoxy group, or a branched alkyl group in which one CH₂ group is substituted with —OCO— or —COO—. M^{Q} denotes a trans-1,4-cyclohexylene group, a 1,4-phenylene group, or a single bond, preferably a trans-1,4-cyclohexylene group or a 1,4-phenylene group.

More specifically, a compound represented by the general formula (Q) is preferably a compound represented by one of the general formulae (Q-a) to (Q-d).

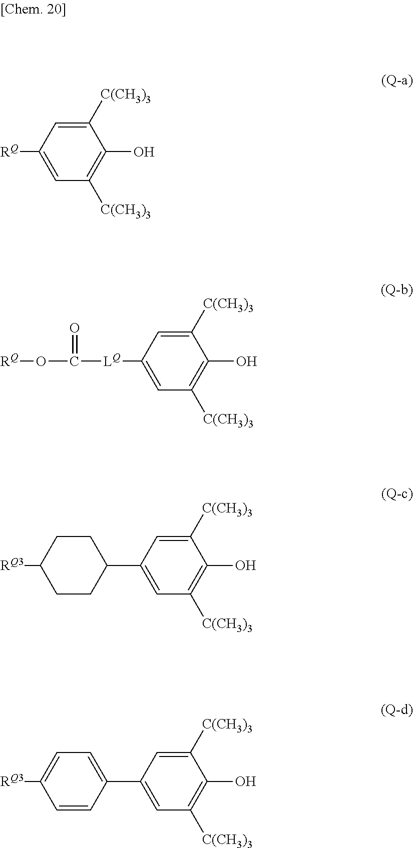

In these formulae, R^{Q1} is preferably a linear or branched alkyl group having 1 to 10 carbon atoms, R^{Q2} is preferably a linear or branched alkyl group having 1 to 20 carbon atoms, R^{Q3} is preferably a linear alkyl group, a branched alkyl group, a linear alkoxy group, or a branched alkoxy group each having 1 to 8 carbon atoms, and L^{Q} is preferably a linear or branched alkylene group having 1 to 8 carbon atoms. Among the compounds represented by the general formulae (Q-a) to (Q-d), more preferred are compounds represented by the general formulae (Q-c) and (Q-d).

A composition according to the present invention preferably contains one or two, more preferably one to five, compounds represented by the general formula (Q). The amount of compound(s) represented by the general formula (Q) in a composition according to the present invention preferably ranges from 0.001% to 1%, more preferably 0.001% to 0.1%, particularly preferably 0.001% to 0.05%.

In a composition containing a polymerizable compound according to the present invention, the polymerizable compound is polymerized by ultraviolet irradiation to impart liquid crystal alignment capability to the composition. Such a composition can be used in liquid crystal display devices that can control the amount of transmitted light utilizing the birefringence of the composition.

### (Liquid Crystal Display Device)

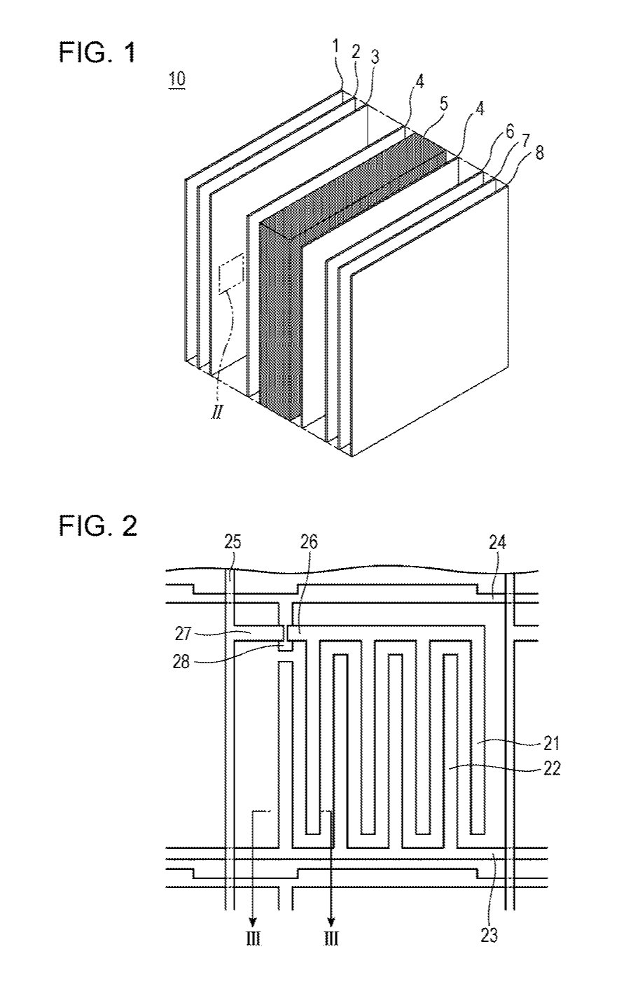

A liquid crystal composition according to the present invention is applied to an IPS mode liquid crystal display device having the following structure. An IPS mode liquid crystal display device according to the present invention will be described below with reference to FIGS. 1 to 6.

FIG. 1 is a schematic view of a liquid crystal display device. In FIG. 1, components are separated for convenience of explanation. As illustrated in FIG. 1, a liquid crystal display device 10 according to the present invention is an IPS mode liquid crystal display device that includes a liquid crystal layer 5 between a first substrate 2 and a second substrate 7. The liquid crystal layer 5 is formed of a liquid crystal composition according to the present invention.

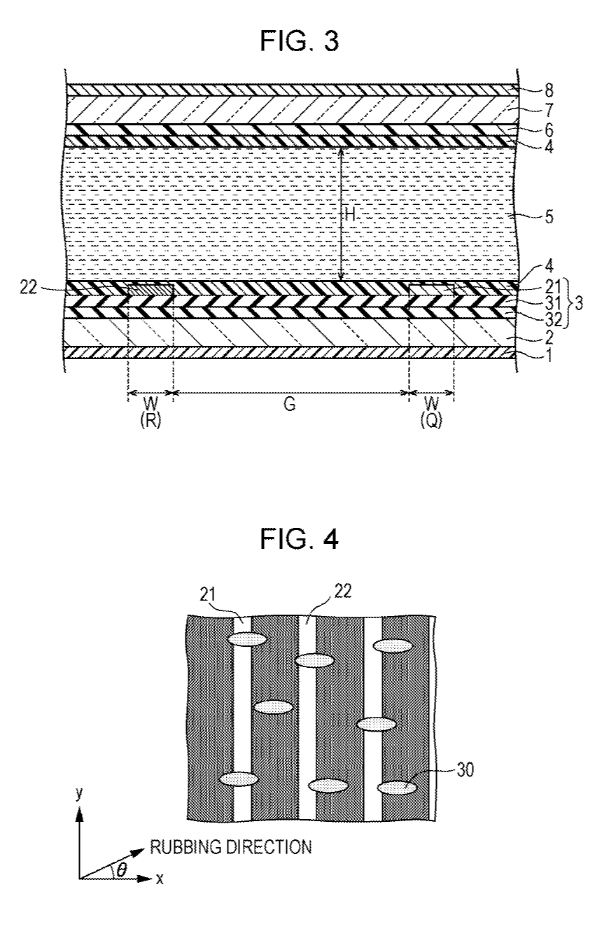

An electrode layer 3 is formed on a surface of the first substrate 2 facing the liquid crystal layer 5. A pair of alignment films 4 are disposed between the liquid crystal layer 5 and the first substrate 2 and between the liquid crystal layer 5 and the second substrate 7. The alignment films 4 directly abut on the liquid crystal composition forming the liquid crystal layer 5 and induce homogeneous alignment. Liquid crystal molecules in the liquid crystal composition are aligned approximately parallel to the first substrate 2 and the second substrate 7 during no voltage application. As illustrated in FIGS. 1 and 3, the first substrate 2 and the second substrate 7 may be disposed between a pair of polarizers 1 and 8. Furthermore, as illustrated in FIG. 1, a color filter 6 may be disposed between the second substrate 7 and the alignment film 4.

Thus, the liquid crystal display device 10 according to the present invention includes the first polarizer 1, the first substrate 2, the electrode layer 3, the alignment film 4, the liquid crystal layer 5 containing a liquid crystal composition, the alignment film 4, the color filter 6, the second substrate 7, and the second polarizer 8 stacked one by one. The first substrate 2 and the second substrate 7 may be made of glass or a flexible material, such as a plastic. At least one of the first substrate 2 and the second substrate 7 is made of a transparent material, and the other may be made of a transparent material or an opaque material, such as a metal or silicon. The two substrates are bonded together via a sealing material and a sealant, such as an epoxy thermosetting composition, disposed on the peripheral region. The distance between the substrates may be maintained, for example, with a granular spacer, such as glass particles, plastic particles, or alumina particles, or a resin spacer column formed by photolithography.

The first electrode and the second electrode are preferably transparent electrodes to improve transmittance. A transparent electrode can be formed of an oxide semiconductor (ZnO, InGaZnO, SiGe, GaAs, indium zinc oxide (IZO), indium tin oxide (ITO), SnO, TiO, or AZTO (AlZnSnO)) by sputtering. The transparent electrode may have a thickness in the range of 10 to 200 nm. An amorphous ITO film may be converted into a polycrystalline ITO film by firing to decrease electrical resistance.

FIG. 2 is a fragmentary enlarged plan view of a region within the line II of the electrode layer 3 formed on the first substrate 2 in FIG. 1. As illustrated in FIG. 2, the electrode layer 3 including a thin-film transistor formed on the first substrate 2 includes a matrix of a plurality of gate bus lines 24 and a plurality of data bus lines 25 crossing each other. The gate bus lines 24 relay scanning signals. The data bus lines 25 relay display signals. FIG. 2 illustrates only a pair of gate bus lines 24 and a pair of data bus lines 25.

A region surrounded by the gate bus lines 24 and the data bus lines 25 forms a unit pixel of a liquid crystal display. A first electrode 21 and a second electrode 22 are formed in the unit pixel. A thin-film transistor that includes a source electrode 27, a drain electrode 26, and a gate electrode 28 is disposed near an intersecting portion at which the gate bus lines 24 and the data bus lines 25 cross each other. The thin-film transistor is coupled to the first electrode 21 as a switching device for supplying display signals to the first electrode 21. A common line 23 is disposed in parallel with the gate bus lines 24. The common line 23 is coupled to the second electrode 22 to supply common signals to the second electrode 22. The gate bus lines 24, the data bus lines 25, and the common line 23 are preferably formed of a metal film, more preferably Al, Cu, Au, Ag, Cr, Ta, Ti, Mo, Ni, or an alloy thereof, particularly preferably wires of Mo, Al or an alloy thereof.

FIG. 3 is a cross-sectional view of the liquid crystal display device illustrated in FIG. 1 taken along the line III-III of FIG. 2. A gate-insulating layer 32 covering the gate bus lines 24 and covering almost the entire surface of the first substrate 2 is disposed on the first substrate 2. An insulating protective layer 31 is disposed on the gate-insulating layer 32. The linear first electrode 21 and the linear second electrode 22 are disposed separately on the insulating protective film 31. The insulating protective layer 31 is a layer having an insulation function and is formed of a silicon nitride film, a silicon dioxide film, a silicon oxynitride film, or the like.

The color filter 6 preferably forms a black matrix to prevent light leakage. The black matrix (not shown) is preferably formed in a portion corresponding to the thin-film transistor.

The black matrix, together with a color filter, may be disposed on a substrate opposite an array substrate or on the array substrate side. Alternatively, the black matrix may be disposed on an array substrate, and a color filter may be disposed on the other substrate. The black matrix may be separated from a color filter, or different color filters may be stacked to decrease transmittance.

A pair of alignment films 4 are disposed on the electrode layer 3 and the color filter 6. The alignment films 4 directly abut on a liquid crystal composition forming the liquid crystal layer 5 and induce homogeneous alignment. The alignment, films 4 are rubbed polyimide films, for example.

In the polarizer 1 and the polarizer 8, the polarization axis of each polarizer can be adjusted to improve the viewing angle and contrast. The polarizer 1 and the polarizer 8 preferably have orthogonal transmission axes such that the transmission axis of each polarizer can operate in the normally black mode. In particular, one of the polarizer 1 and the polarizer 8 is preferably disposed so as to have a transmission axis parallel to the alignment direction of liquid crystal molecules during no voltage application. The refractive index anisotropy Δn of the liquid crystal composition is preferably adjusted for the cell thickness d to maximize the contrast. A retardation film for increasing the viewing angle may also be used.

In the embodiment illustrated in FIGS. 2 and 3, the first electrode 21 and the second electrode 22 are interdigitated electrodes on the insulating protective layer 31, that is, on the same layer, and are separated from each other and interdigitated. The interelectrode distance G between the first electrode 21 and the second electrode 22 and the thickness H of the liquid crystal layer between the first substrate 2 and the second substrate 7 satisfy the relationship G≥H. The interelectrode distance G is the shortest distance between the first electrode 21 and the second electrode 22 parallel to the substrate and in the embodiment illustrated in FIGS. 2 and 3 refers to the distance in a direction perpendicular to the interdigitated lines between the first electrode 21 and the second electrode 22. The thickness H of the liquid crystal layer between the first substrate 2 and the second substrate 7 is the shortest distance between the outermost surfaces of the first substrate 2 and the second substrate 7, more specifically refers to the distance (cell gap) between the alignment films 4 (the outermost surface) on the first substrate 2 and the second substrate 7, and as illustrated in FIG. 3 refers to the thickness of the liquid crystal layer.

In the present invention, the interelectrode distance G between the first electrode and the second electrode and the thickness H of the liquid crystal layer between the first substrate and the second substrate preferably have a difference satisfying the relationship 0≤G−H≤0.5 μm. Although a liquid crystal composition with a higher elastic constant requires a greater drive voltage, satisfying the relationship can decrease the drive voltage. Although a liquid crystal composition with a high elastic constant is used in the present invention, using a liquid crystal composition according to the present invention and satisfying the relationship 0≤G−H≤0.5 μm can decrease the drive voltage and improve the response speed. G=H is preferably more than 0, preferably 0.5 or less, preferably 0.4 or less, preferably 0.3 or less, preferably 0.2 or less, preferably 0.15 or less, preferably 0.1 or less.

An IPS liquid crystal display device utilizes an electric field parallel to a substrate face between the first electrode 21 and the second electrode to drive liquid crystal molecules. The electrode width Q of the first electrode 21 and the electrode width R of the second electrode 22 are preferably determined such that the electric field can drive all the liquid crystal molecules in the liquid crystal layer 5. More specifically, from the perspective of transmittance, the electrode width W of at least one of the first electrode and the second electrode is preferably 3 μm or less, preferably 2.8 μm or less, preferably 2.6 μm or less, preferably 2.4 μm or less, preferably 2.2 μm or less, preferably 2.0 μm or less, preferably 1.8 μm or less, preferably 1.6 μm or less, preferably 1.4 μm or less, preferably 1.2 μm or less. However, a narrow electrode width makes the formation difficult and results in a low yield of the display device. Thus, practically, the electrode width W is preferably 0.5 μm or more, preferably 0.7 μm or more, preferably 0.8 μm or more, preferably 0.9 μm or more, preferably 1.0 μm or more. The electrode width refers to the width (line width) of an interdigitated line between the first electrode 21 and the second electrode 22 along the short axis.

In the present invention, the interelectrode distance G between the first electrode and the second electrode and the electrode width W of at least one of the first electrode and the second electrode preferably satisfy the relationship G−W≤3 μm. The electrode width W of at least one of the first electrode and the second electrode may be the electrode width Q of the first electrode 21 or the electrode width R of the second electrode 22. Preferably, the electrode widths Q and R are identical and satisfy the relationship W=Q=R. Using a liquid crystal composition according to the present invention and satisfying G−W≤3 μm can decrease the drive voltage and improve the response speed. In order to decrease the drive voltage and prevent the decrease in transmittance, the lower limit of G−W is preferably 0 or more, preferably 0.1 or more, preferably 0.1 or more, preferably 0.2 or more, preferably 0.3 or more, preferably 0.5 or more. The upper limit is preferably 2.8 or less, preferably 2.5 or less, preferably 2.3 or less, preferably 2.0 or less, preferably 1.5 or less, preferably 1.3 or less, preferably 1.2 or less, preferably 1.1 or less.

In the present invention, the relationship 0≤G−H≤0.5 μm or the relationship G−W≤3 μm is preferably satisfied. More preferably, both the relationship 0≤G−H≤0.5 μm and the relationship G−W≤3 μm are satisfied.

FIG. 4 is a schematic view of the alignment direction of a liquid crystal induced by the alignment film 4. In the present invention, a liquid crystal composition with negative dielectric constant anisotropy is used. Thus, taking an x-axis in a direction perpendicular to comb-shaped lines of the first electrode 21 and the second electrode 22 (a direction in which a horizontal electric field is formed), the angle θ between the x-axis and the major axis direction of liquid crystal molecules 30 preferably ranges from 0 to 45 degrees. In the embodiment illustrated in FIG. 4, the angle θ between the x-axis and the major axis direction of the liquid crystal molecules 30 is approximately 0 degrees. The angle θ between the x-axis and the major axis direction of the liquid crystal molecules 30 preferably ranges from 0 to 40 degrees, preferably 0 to 35 degrees, more preferably 0 to 30° C. Such induction of the alignment direction of a liquid crystal is intended to increase the maximum transmittance and contrast of the liquid crystal display.

The IPS liquid crystal display 10 having such a structure supplies image signals (voltages) to the first electrode 21 through a thin film TFT and thereby generates an electric field, which drives the liquid crystal, between the first electrode 21 and the second electrode 22. Thus, without voltage application, the major axis direction of the liquid crystal molecules 30 is parallel to the alignment direction of the alignment film 4. Upon voltage application the major axis direction of the liquid crystal molecules 30 in the liquid crystal layer 5 is inclined at an angle depending on the applied voltage relative to the interdigitated lines between the first electrode 21 and the second electrode 22. The liquid crystal molecules 30 in FIG. 4 are schematically illustrated to show the movement of the liquid crystal molecules of the liquid crystal composition and do not represent particular liquid crystal molecules alone.

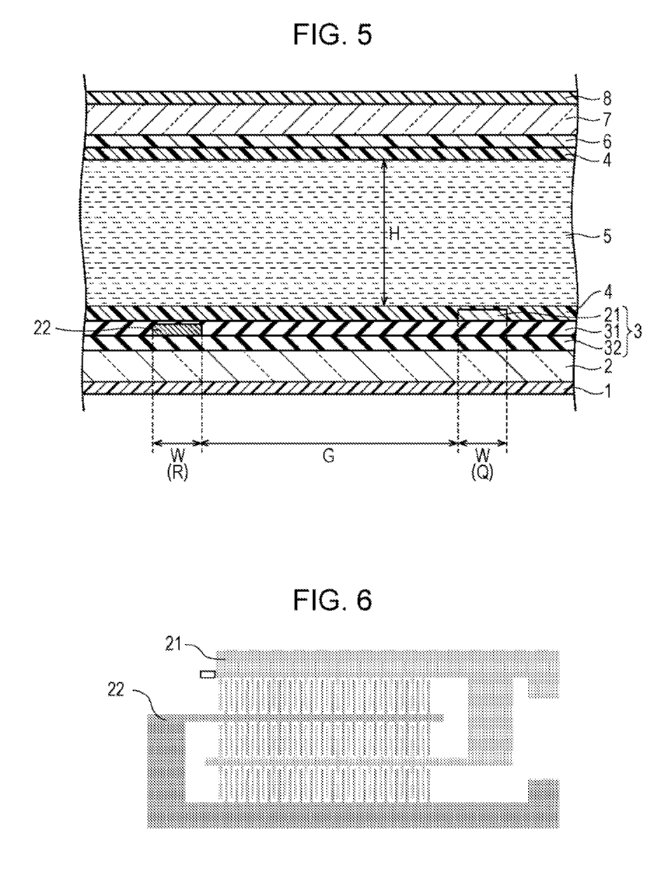

The IPS liquid crystal display device illustrated in FIGS. 1 to 4 is only an example, and other various embodiments are possible without departing from the technical idea of the present invention. For example, FIG. 5 illustrates another structure of the first electrode 21 and the second electrode 22 in a pixel. FIG. 6 is another cross-sectional view of the liquid crystal display device illustrated in FIG. 1 taken along the line III-III of FIG. 2. As illustrated in FIG. 6, the second electrode 22 may be disposed on the gate-insulating layer 32, the second electrode may be covered with the insulating protective layer 31, the first electrode 21 may be disposed on the insulating protective layer 31, and the first electrode 21 and the second electrode 22 may be disposed on the different layers.

In a liquid crystal display device according to the present invention, for example, a wire and the electrode layer 3 can be formed of a metallic material, such as an electrode layer Al or an alloy thereof, on the first substrate 2 by sputtering. The color filter 6 can be produced by a pigment dispersion method, a printing method, an electrodeposition method, or a staining method. For example, in a method for producing a color filter by a pigment dispersion method, a curable coloring composition for a color filter is applied to a transparent substrate, is patterned, and is cured by heating or light irradiation. This process is repeatedly performed to produce red, green, and blue pixel units for color filters. A color filter may be disposed near a substrate having a TFT.

The first substrate 2 is opposed to the second substrate 7 with the electrode layer 3 and the alignment film 4 interposed therebetween. The distance between the substrates may be adjusted with a spacer. The distance between the substrates is preferably adjusted such that the liquid crystal layer has a thickness in the range of 1 to 100 μm. The liquid crystal layer preferably has a thickness in the range of 1 to 20 μm, preferably 1 to 15 μm, preferably 1 to 10 μm, preferably 1.3 to 10 μm, preferably 1.5 to 10 μm, preferably 1.5 to 8 μm, preferably 1.5 to 5 μm preferably 1.5 to 4 μm, preferably 1.3 to 3.5 μm, preferably 2.0 to 3 μm. When a polarizer is used, the product of the refractive index anisotropy An of a liquid crystal and the cell thickness d is preferably adjusted to maximize contrast When two polarizers are used, a polarization axis of each polarizer may be adjusted to improve the viewing angle or contrast. A retardation film for increasing the viewing angle may also be used. Subsequently, a sealant, such as a thermosetting epoxy composition, is applied to a substrate by screen printing such that a liquid crystal inlet is formed. The substrates are then joined and heated to cure the sealant.

A composition can be placed between two substrates by a conventional vacuum injection or one drop fill (ODF) method. Although the vacuum injection method causes no drop marks, the vacuum injection method has a problem of leaving an injection mark. In the present invention, a display device is preferably produced by the ODF method. In a process of manufacturing a liquid crystal display device by the ODF method, a light, and heat curable epoxy sealant is applied in a closed-loop bank shape to a back or front plane substrate using a dispenser. A predetermined amount of composition is dropped inside the closed-loop bank while degassing is performed. The front plane and the back plane are joined to manufacture the liquid crystal display device. In the present invention, the ODF method can prevent or reduce the occurrence of drop marks resulting from dropping of a liquid crystal composition on a substrate. Drop marks are defined as a phenomenon in which marks of dropping of a liquid crystal composition appear white in black display.

The occurrence of drop marks depends greatly on the liquid crystal material to be injected and also depends to some extent on the structure of the display device. In IPS mode liquid crystal display devices, thin-film transistors, and the interdigitated first electrode 21 and second electrode 22, or the first electrode 21 and second electrode 22 having slits in a display device are separated from the liquid crystal composition only by the thin alignment film 4 or by the thin alignment film 4 and the thin insulating protective layer 31, which are unlikely to completely block ionic materials. Thus, the occurrence of drop marks due to an interaction between a metallic material of electrodes and the liquid crystal composition cannot be avoided. However, the use of a liquid crystal composition according to the present invention in an IPS liquid crystal display device can effectively prevent or reduce the occurrence of drop marks.

In a process of manufacturing a liquid crystal display device by the ODE method, the amount of liquid crystal to be injected must be optimized according to the size of the liquid crystal display device. A liquid crystal composition according to the present invention has a little influence on a sudden pressure change in a dropping apparatus or an impact during dropping of the liquid crystal, for example, and a liquid crystal can be stably dropped for extended periods. This can maintain a high yield of the liquid crystal display device. In particular, in small liquid crystal display devices frequently used in recent popular smartphones, due to a small optimum amount of liquid crystal to be injected, it is difficult to control the deviation from the optimum value within a certain range. However, the use of a liquid crystal composition according to the present invention allows a liquid crystal material to be ejected in a proper amount even in small liquid crystal display devices.

In order to achieve high liquid crystal alignment capability, an appropriate rate of polymerization is desirable. Thus, for a liquid crystal composition according to the present invention containing a polymerizable compound the polymerizable compound is preferably polymerized by irradiation with an active energy beam, such as ultraviolet light or an electron beam, alone, in combination, or in sequence. When ultraviolet light is used, a polarized or unpolarized light source may be used. For polymerization of a composition containing a polymerizable compound between two substrates, at least the substrate to be irradiated must be transparent to an active energy beam. Only a particular portion may be polymerized using a mask during light irradiation, and then the condition such as an electric field, a magnetic field, or temperature may be altered to change the alignment state of an unpolymerized portion, which is then polymerized by irradiation with an active energy beam. In particular, for ultraviolet exposure, a composition containing a polymerizable compound is preferably exposed to ultraviolet light in an alternating electric field. The alternating electric field preferably has a frequency in the range of 10 to 10,000 Hz, more preferably 60 to 10,000 Hz. The voltage depends on the desired pretilt angle of a liquid crystal display device. In other words, the pretilt angle of a liquid crystal display device can be controlled through the voltage to be applied. Transverse electric field MVA mode liquid crystal display devices preferably have a pretilt angle in the range of 80 to 89.9 degrees in terms of stability of alignment and contrast.

The irradiation temperature is preferably in such a range that a composition according to the present invention can retain its liquid crystal state. The polymerization temperature is preferably close to room temperature, typically in the range of 15° C. to 35° C. Examples of lamps for generating ultraviolet light include metal halide lamps, high-pressure mercury lamps, and ultrahigh-pressure mercury lamps. The wavelength of ultraviolet light is preferably outside the absorption wavelength range of the composition. Ultraviolet light is preferably filtered as required. The ultraviolet light intensity preferably ranges from 0.1 mW/cm2 to 100 W/cm2, more preferably 2 mW/cm2 to 50 W/cm2. The ultraviolet light energy can be appropriately determined and preferably ranges from 10 mJ/cm2 to 500 J/cm2, more preferably 100 mJ/cm2 to 200 J/cm2. During ultraviolet irradiation, the ultraviolet light intensity may be changed. The ultraviolet irradiation time depends on the ultraviolet light intensity and preferably ranges from 10 to 3600 seconds, more preferably 10 to 600 seconds.

A color filter may be produced by a pigment dispersion method, a printing method, an electrodeposition method, or a staining method. For example, in a method for producing a color filter by a pigment dispersion method, a curable coloring composition for a color filter is applied to a transparent substrate, is patterned, and is cured by heating or light irradiation. This process is repeatedly performed to produce red, green, and blue pixel units for color filters. A pixel electrode may be formed on the substrate. The pixel electrode includes an active element, such as a TFT, a thin-film diode, or a metal insulator metal resistivity element.

The substrates face each other with the transparent electrode layer interposed therebetween. The distance between the substrates may be adjusted with a spacer. The distance between the substrates is preferably adjusted such that the resulting light control layer has a thickness in the range of 1 to 100 μm, more preferably 1.5 to 10 μm. When a polarizer is used, the product of the refractive index anisotropy Δn of a liquid crystal and the cell thickness d is preferably adjusted to maximize contrast. When two polarizers are used, a polarization axis of each polarizer may be adjusted to improve the viewing angle or contrast. A retardation film for increasing the viewing angle may also be used. For example, the spacer may be a columnar spacer formed of glass particles, plastic particles, alumina particles, or a photoresist material. Subsequently, a sealant, such as a thermosetting epoxy composition, is applied to a substrate by screen printing such that a liquid crystal inlet is formed. The substrates are then joined and heated to cure the sealant.

A composition containing a polymerizable compound can be placed between two substrates by a conventional vacuum injection or ODF method. Although the vacuum injection method causes no drop marks, the vacuum injection method has a problem of leaving an injection mark. In the present invention, a display device is preferably produced by the ODF method. In a process of manufacturing a liquid crystal display device by the ODF method, a light and heat curable epoxy sealant is applied in a closed-loop bank shape to a back or front plane substrate using a dispenser. A predetermined amount of composition is dropped inside the closed-loop bank while degassing is performed. The front plane and the back plane are joined to manufacture the liquid crystal display device. A composition according to the present invention can be consistently dropped in the ODF process and can therefore be suitably used.

In order to achieve high liquid crystal alignment capability, an appropriate rate of polymerization is desirable. Thus, a polymerizable compound is preferably polymerized by irradiation of an active energy beam, such as ultraviolet light or an electron beam, alone, in combination, or in sequence. When ultraviolet light is used, a polarized or unpolarized light source may be used. For polymerization of a composition containing a polymerizable compound between two substrates, at least the substrate to be irradiated must be transparent to an active energy beam. Only a particular portion may be polymerized using a mask during light irradiation, and then the condition such as an electric field, a magnetic field, or temperature may be altered to change the alignment state of an unpolymerized portion, which is then polymerized by irradiation with an active energy beam. In particular, for ultraviolet exposure, a composition containing a polymerizable compound is preferably exposed to ultraviolet light in an alternating electric field. The alternating electric field preferably has a frequency in the range of 10 to 10,000 Hz, more preferably 60 to 10,000 Hz. The voltage depends on the desired pretilt angle of a liquid crystal display device. In other words, the pretilt angle of a liquid crystal display device can be controlled through the voltage to be applied. Transverse electric field MVA mode liquid crystal display devices preferably have a pretilt angle in the range of 80 to 89.9 degrees in terms of stability of alignment and contrast.

The irradiation temperature is preferably in such a range that a composition according to the present invention can retain its liquid crystal state. The polymerization temperature is preferably close to room temperature, typically in the range of 15° C. to 35° C. Examples of lamps for generating ultraviolet light include metal halide lamps, high-pressure mercury lamps, and ultrahigh-pressure mercury lamps. The wavelength of ultraviolet light is preferably outside the absorption wavelength range of the composition. Ultraviolet light is preferably filtered as required. The ultraviolet light intensity preferably ranges from 0.1 mW/cm2 to 100 W/cm2, more preferably 2 mW/cm2 to 50 W/cm2. The ultraviolet light energy can be appropriately determined and preferably ranges from 10 mJ/cm2 to 500 J/cm2, more preferably 100 mJ/cm2 to 200 J/cm2. During ultraviolet irradiation, the ultraviolet light intensity may be changed. The ultraviolet irradiation time depends on the ultraviolet light, intensity and preferably ranges from 10 to 3600 seconds, more preferably 10 to 600 seconds.

In the liquid crystal display device, the liquid crystal layer 5 between the first substrate 2 and the second substrate 7 is formed by a vacuum injection or one drop fill (ODF) method, for example. In the present invention, the ODF method can prevent or reduce the occurrence of drop marks resulting from dropping of a liquid crystal composition on a substrate. Drop marks are defined as a phenomenon in which marks of dropping of a liquid crystal composition appear white in black display.

The occurrence of drop marks depends greatly on the liquid crystal material to be injected and also depends to some extent on the structure of the display device. In a liquid crystal display device according to the present invention, thin-film transistors and the interdigitated pixel electrode 21 or the pixel electrode 21 having slits in a display device are separated from the liquid crystal composition only by the thin alignment film 4 or by the thin alignment film 4 and the thin insulating protective layer 18, which are unlikely to completely block ionic materials. Thus, the occurrence of drop marks due to an interaction between a metallic material of electrodes and the liquid crystal composition cannot be avoided. However, the use of a liquid crystal composition according to the present invention in a liquid crystal display device according to the present invention can effectively prevent or reduce the occurrence of drop marks.

In a process of manufacturing a liquid crystal display device by the ODF method, the amount of liquid crystal to be injected must be optimized according to the size of the liquid crystal display device. A liquid crystal composition according to the present invention has a little influence on a sudden pressure change in a dropping apparatus or an impact during dropping of the liquid crystal, for example, and a liquid crystal can be stably dropped for extended periods. This can maintain a high yield of the liquid crystal display device. In particular, in small liquid crystal display devices frequently used in recent popular smartphones, due to a small optimum amount of liquid crystal to be injected, it is difficult to control the deviation from the optimum value within a certain range. However, the use of a liquid crystal composition according to the present invention allows a liquid crystal material to be ejected in a proper amount even in small liquid crystal display devices.

### EXAMPLES

The following abbreviations are used to describe compounds in the examples. In the abbreviations, n denotes a natural number.

### (Side Chain)

-n —CₙH₂ₙ₊₁ a linear alkyl group having n carbon atoms

n- CₙH₂ₙ₊₁— a linear alkyl group having n carbon atoms

—On —OCₙH₂ₙ₊₁ a linear alkoxy group having n carbon atoms

nO— CₙH₂ₙ₊₁O— a linear alkoxy group having n carbon atoms

—V —CH═CH₂

V— CH₂═CH—

—V1 —CH═CH—CH₃

1V— CH₃—CH═CH—

-2V —CH₂—CH₂—CH═CH₂

V2- CH₂═CH—CH₂—CH₂—

-2V1 —CH₂—CH₂—CH═CH—CH₃

1V2- CH₃—CH═CH—CH₂—CH₂—

(Linking Group)

-n- —CₙH₂ₙ—

-nO— —CₙH₂ₙ—O—

—On- —O—CₙH₂ₙ—

—COO— —C(═0)—O—

—OCO— —O—C(═O)—

—CF₂O— —CF₂—O—

—OCF₂— O—CF₂—

—CH═CH— —CH═CH—

### (Ring Structure)

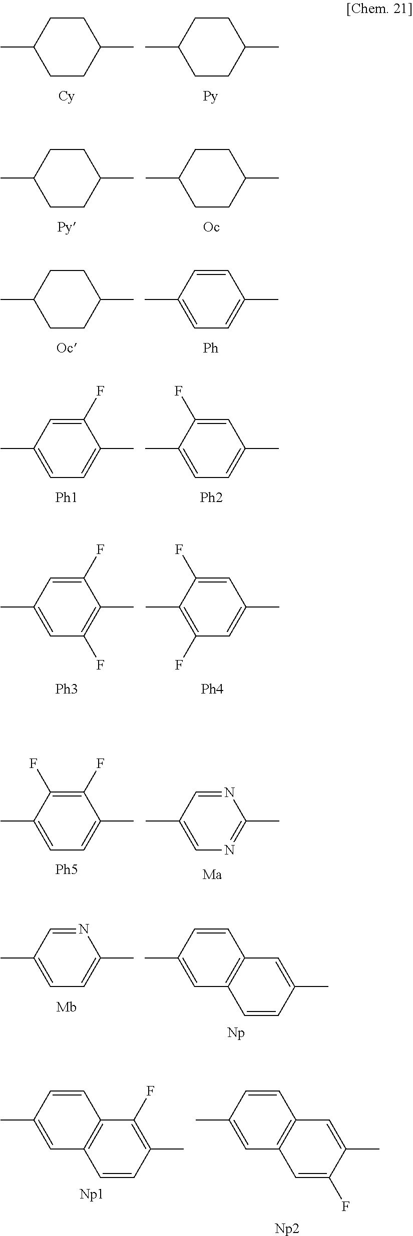

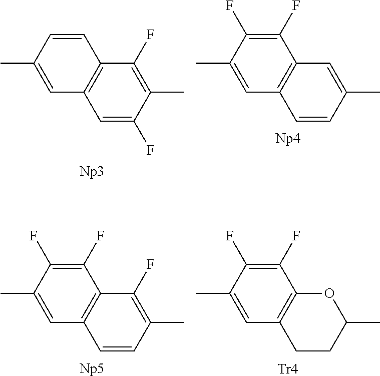

The following characteristics were measured in the examples.

Tₙᵢ: nematic phase-isotropic liquid phase transition temperature (° C.)

T_{→N}: nematic phase lower limit temperature (° C.)

Δn: refractive index anisotropy at 20°C.

Δε: dielectric constant anisotropy at 20° C.

γ₁: rotational viscosity (mPa·s) at 20° C.

K₃₃: elastic constant K₃₃ (pN) at 20° C.

Response speed: The response speed of a VA liquid crystal display device at 20° C. was measured with an electro-optical measurement apparatus DMS703 manufactured by Autronic.

VHR (UV): voltage holding ratio (%) at a frequency of 60 Hz, at an applied voltage of 1 V, and at 60° C. after irradiation with light with an illuminance of 100 mW/cm2 at 365 nm for 120 seconds using a high-pressure mercury lamp

Image-sticking: In the evaluation of image-sticking in a liquid crystal display device, a predetermined fixed pattern was displayed in a display area for a test time. The test time at which the after-image of the fixed pattern being uniformly displayed on the entire screen reached an unacceptable after-image level was measured.

1) The test time refers to the display time of the fixed pattern. A longer test time indicates suppression of an after-image and higher performance.

2) An unacceptable after-image level means that the observed after-image fails to meet delivery standards.

Example)

Sample A: 1000 hours

Sample B: 500 hours

Sample C: 200 hours

Sample D: 100 hours

Performance A>B>C>D

Drop Marks:

In the evaluation of drop marks in a liquid crystal display, white drop marks on a black background on the entire screen were visually inspected according to the following five ratings.

5: No drop marks (excellent)

4: A few acceptable drop marks (good)

3: Several drop marks on the borderline of acceptability (fair under certain conditions)

2: Unacceptable drop marks (poor)

1: Terrible drop marks (very poor)

Nematic phase stability at low temperatures:

Nematic phase stability at low temperatures was evaluated by preparing a composition, weighing 1 g of the composition in a 2-mL sample bottle, subjecting the sample bottle to cycles of temperature changes of “−20° C. (for 1 hour) temperature rise (0.1° C./min)→0° C. (for 1 hour)→temperature rise (0.1° C./min)→20° C. (for 1 hour)→temperature drop (−0.1° C./min)→0° C. (for 1 hour)→temperature drop (−0.1° C./min)→−20° C.” in a temperature controlled test chamber, visually inspecting the sample bottle for precipitates from the composition, and determining the test time at which precipitates were observed.

A longer test time indicates a stable liquid crystal phase for longer periods and higher nematic phase stability at low temperatures.

Example)

Sample A: 24 hours

Sample B: 120 hours

Sample C: 48 hours

Sample D: 240 hours

Performance D>B>C>A

Volatility/Contamination of Manufacturing Apparatus:

The volatility of a liquid crystal material was evaluated in terms of mass change when 0.020 g of a liquid crystal composition was left at 1 Pa for 90 minutes.

A smaller mass change indicates higher performance, that is, lower volatility and less contamination of a manufacturing apparatus.

Example)

Sample A: 0.019 g

Sample B: 0.017 g

Sample C: 0.018 g

Sample D: 0.013 g

Performance A>C>B>D

### (Example 1, Comparative Example 1, Comparative Example 2, and Example 2)

Liquid crystal compositions according to Example 1, Comparative Example 1, Comparative Example 2, and Example 2 were prepared. The following table lists the physical properties of these liquid crystal compositions.

TABLE 1

| | | Comparative | Comparative | Exam- |
|---|---|---|---|---|
| | Example 1 | example 1 | example 2 | ple 2 |
| (i.1) | 7 | 7 | 7 | 7 |
| (i.3) | 7 | 7 | 7 | 7 |
| (ii.2) | 13 | 13 | 13 | 13 |
| (ii.4) | 19 | 19 | 12 | 19 |
| (iii.1) | — | — | — | 20 |
| (iii.3) | 20 | 12 | 10 | — |
| (iii.4) | 5 | 5 | 5 | 5 |
| (iv.1) | 8 | 5 | 8 | 8 |
| (iv.2) | 7 | 7 | 7 | 7 |
| (v.1) | 4 | 4 | 4 | 4 |
| (vi.1) | 6 | 6 | 6 | 6 |
| (L-2.4) | 4 | 4 | 4 | 4 |
| 3-CyCy-V | — | 8 | — | — |
| V2-PhPh-1 | — | 3 | — | — |
| 3-Cy-1O-Ph5-O2 | — | — | 7 | — |
| 3-Cy-CH═CH-Cy-2 | — | — | 10 | — |
| Tₙᵢ | 74.3 | 72.8 | 59.9 | 66.8 |
| T_{→N} | −22 | −32 | −17 | −32 |
| Δn | 0.107 | 0.107 | 0.102 | 0.104 |
| Δε | −2.9 | −2.9 | −2.8 | −2.9 |
| γ1 | 92 | 88 | 73 | 85 |
| K₃₃ | 13.6 | 13.4 | 11.3 | 12.5 |
| γ1/K₃₃ | 6.8 | 6.6 | 6.5 | 6.8 |

The composition according to Example I contains a compound represented by the general formula (i), a compound represented by the general formula (ii), a compound represented by the general formula (iii), a compound represented by the general formula (iv), a compound represented by the general formula (v), and a compound represented by the general formula (vi) described in Claim 1 of the present application, and the amount of these compounds is 96%. p The composition according to Comparative Example 1 contains smaller amounts of a compound represented by the general formula (iii) and a compound represented by the general formula (iv) than the composition according to Example 1, 3-CyCy-1 and V2-PhPh-1 are added to the composition, and the total amount of a compound represented by the general formula (i), a compound represented by the general formula (ii), a compound represented by the general formula (iii), a compound represented by the general formula (iv), a compound represented by the general formula (v), and a compound represented by the general formula (vi) in the composition is 85%.

The composition according to Comparative Example 2 contains a smaller amounts of a compound represented by the general formula (ii) and a compound represented by the general formula (iii) than the composition according to Example 1, 3-Cy-1O—PH5-O2 and 3-Cy-CH═CH-Cy-2 are added to the composition, and the total amount of a compound represented by the general formula (i), a compound represented by the general formula (ii), a compound represented by the general formula (iii), a compound represented by the general formula (iv), a compound represented by the general formula (v), and a compound represented by the general formula (vi) in the composition is 79%.

The following table lists the evaluation results of the compositions according to Example 1, Comparative Example 1, Comparative Example 2, and Example 2.

TABLE 2

| | | | Comparative | | Comparative | | | |
|---|---|---|---|---|---|---|---|---|
| | Example 1 | | example 1 | | example 2 | | Example 2 | |
| Image-sticking | 1000 | | 100 | | 300 | | 1000 | |
| Drop marks | 5 | | 2 | | 3 | | 4 | |
| Nematic phase | 240 | hours | 240 | hours | 48 | hours | 240 | hours |
| stability at | | | | | | | | |
| low | | | | | | | | |
| temperatures | | | | | | | | |
| Volatility/ | 0.019 | g | 0.017 | g | 0.018 | g | 0016 | g |
| contamination | | | | | | | | |
| of | | | | | | | | |
| manufacturing | | | | | | | | |
| apparatus | | | | | | | | |

Although the composition according to Comparative Example 1 had lower γ₁ than the composition according to Example 1, the composition according to Comparative Example 1 had a lower Tₙᵢ and significantly poor image-sticking and drop marks. The volatility also worsened.

The composition according to Comparative Example 2 had improved γ₁ but had a significantly decreased Tₙᵢ and significantly poor image-sticking, drop marks, and nematic phase stability at low temperatures.

The composition according to Example 1 had desired characteristics, such as Tₙᵢ, Δε, γ₁, and nematic phase stability at low temperatures, and had improved image-sticking, drop marks, nematic stability at low temperatures, and volatility. A VA liquid crystal display device with a cell thickness of 3.2 μm was manufactured using the composition and was proved to exhibit high-speed response. The VA liquid crystal display device was also proved to have high transmittance required for liquid crystal televisions.

VA liquid crystal display devices manufactured using the compositions according to Example 1, Comparative Example 1, Comparative Example 2, and Example 2 were tested with respect to VHR (UV). Examples 1 and 2 had a sufficiently high VHR (UV) and had high reliability. However, Comparative Examples 1 and 2 had a decreased VHR (UV).

Thus, a composition according to the present invention does not adversely affect the characteristics of liquid crystal display devices, such as Tₙᵢ, Δε, γ₁, and nematic phase stability at low temperatures, as well as the image-sticking characteristics, is less likely to cause drop marks during the manufacture, and has lower volatility in the ODF process. A liquid crystal display device containing the composition has satisfactory high-speed response and reliability.

### REFERENCE SIGNS LIST

1, 8 polarizer

2 first substrate

3 electrode layer

4 alignment film

5 liquid crystal layer

6 color filter

7 second substrate

21 first electrode

22 second electrode

23 common line

24 gate bus line

25 data bus line

26 drain electrode

27 source electrode

28 gate electrode

30 liquid crystal molecules

31 insulating protective layer

32 pate-insulating layer

H thickness of liquid crystal layer between first substrate and second substrate

G interelectrode distance between electrode and the second electrode

W electrode widths of first electrode and the second electrode

R electrode width of second electrode 22

Q electrode width of first electrode 21

1. A composition comprising a compound represented by the general formula (i), a compound represented by the general formula (ii), a compound represented by the general formula (iii), compound represented by the general formula (iv), a compound represented by the general formula (v), and a compound represented by the general formula (vi), wherein the compound represented by the general formula (i), the compound represented by the general formula (ii), the compound represented by the general formula (iii), the compound represented by the general formula (iv), the compound represented by the general formula (v), and the compound represented by the general formula (vi) constitute 90% or more of the composition. 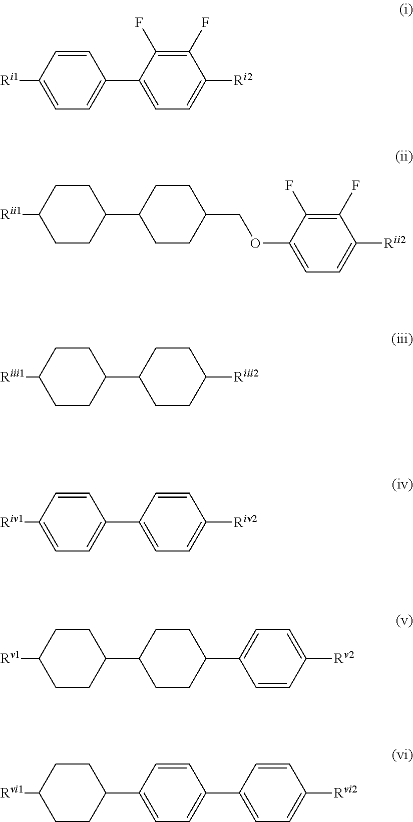
(Rⁱ¹, Rⁱⁱ¹, Rⁱⁱⁱ¹, Rⁱⁱⁱ², R^{iv1}, R^{iv2}, R^{v1}, R^{v2}, R^{vi1}, and R^{vi2} independently denote an alkyl group having 1 to 8 carbon atoms, and Rⁱ² and Rⁱⁱ² independently denote an alkyl group having 1 to 8 carbon atoms or an alkoxy group having 1 to 8 carbon atoms)

2. The composition according to claim 1, further comprising a compound represented by the general formula (L).
R^{L1}-A^{L1}-Z^{L1}A^{L2}-Z^{L2}ₙ_{^{L1}}A^{L3}-R^{L2}(L)
(R^{L1} and R^{L2} independently denote an alkyl group having 1 to 8 carbon atoms, and one —CH₂— or two or more nonadjacent —CH₂— groups in the alkyl group are independently optionally substituted with —CH═CH—, —C≡C—, —O—, —CO—, —COO—, or —OCO—,
n^{L1} is 0, 1, 2, or 3,
A^{L1}, A^{L2}, and A^{L3} independently denote a group selected from the group consisting of
(a) a 1,4-cyclohexylene group (in which one —CH₂— or two or more nonadjacent groups are optionally substituted with —O—),
(b) a 1,4-phenylene group (in which one —CH═ or two or more nonadjacent —CH═ groups are optionally substituted with —N═), and
(c) (c) a naphthalene-2,6-diyl group, a 1,2,3,4-tetrahydronaphthalene-2,6-diyl group, or a decahydronaphthalene-2,6-diyl group (one —CH═ or two or mute nonadjacent groups in the naphthalene-2,6-diyl group or in the 1,2,3,4-tetrahydronaphthalene-2,6-diyl group are optionally substituted with —N═),
the groups (a), (b), and (c) are independently optionally substituted with a cyano group, a fluorine atom, or a chlorine atom,
Z^{L1} and Z^{L2} independently denote a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—, and
if n^{L1} is 2 or 3, a plurality of A^{L2}s may be the same or different, and if n^{L1} is 2 or 3, a plurality of Z^{L3}s may be the same or different, but compounds represented by the general formulae (iii) to (vi) are excluded)

3. A liquid crystal display device comprising the composition according to claim 1.

4. An FFS or IPS liquid crystal display device comprising the liquid crystal composition according to claim 1.
